(19) United States
(12) Patent Application Publication
(10) Pub. No.: US 2004/0131827 A1
(43) Pub. Date: Jul. 8, 2004

(54) Toughened cyanoacrylate compositions

(75) Inventor: Hanns Roland Misiak, Dublin (IE)

Correspondence Address: HENKEL LOCTITE CORPORATION, Legal Department, 1001 Trout Brook Crossing, Rocky Hill, CT, 06067, US

(73) Assignee: LOCTITE (R&D) LIMITED

(21) Appl. No.: 10/336,697

(22) Filed: Jan. 6, 2003

(51) Int. Cl. B32B 1/00

(52) U.S. Cl. 428/143; 428/500; 548/259

(57) ABSTRACT

A cyanoacrylate adhesive composition having a toughening agent comprising poly(vinylidene-co-acrylonitrile) in combination with fumed silica. A useful amount of poly(vinylidene-co-acrylonitrile) is about 1.0% by weight to about 20.0% by weight fumed silica is usefully present in amounts of 1-10% by wt.

### BACKGROUND OF THE INVENTION

1. Field Of The Invention

This invention relates to toughened cyanoacrylate compositions which exhibit improved peel strengths

2. Brief Description Of Related Technology

Cyanoacrylate compositions are well known as one component reactive adhesives, quick bonding and suitable for a variety of substrates. However, traditional cyanoacrylate-based adhesives tend to be brittle, and to have low peel strengths. A variety of additives and fillers have been proposed for addition to cyanoacrylate adhesive compositions to improve toughness and peel strengths.

U.S. Pat. No. 4,102,945 describes a cyanoacrylate adhesive having enhanced peel strengths in which a cyanocrylate is thickened by a copolymer or terpolymer including vinylidene chloride-acrylonitrile copolymers.

U.S. Pat. No. 4,440,910 to O'Connor is directed to cyanoacrylate compositions having improved toughness, achieved through the addition of elastomers, i.e., acrylic rubbers. These rubbers are either (i) homopolymers of alkyl esters of acrylic acid; (ii) copolymers of another polymerizable monomer, such as lower alkenes, with an alkyl ester of acrylic acid or with an alkoxy ester of acrylic acid; (iii) copolymers of alkyl esters of acrylic acid; (iv) copolymers of alkoxy esters of acrylic acid; and (v) mixtures thereof.

U.S. Pat. No. 4,444,933 to Columbus suggests the addition of a vinyl chloride/vinyl acetate copolymer to a cyanoacrylate adhesive to reduce adhesion to human skin.

U.S. Pat. No. 4,560,723 to Millet et al. discloses a cyanoacrylate adhesive composition containing a toughening agent comprising a core-shell polymer and a sustainer comprising an organic compound containing one or more unsubstituted or substituted aryl groups. The sustainer is reported to improve retention of toughness after heat aging of cured bonds of the adhesive.

U.S. Pat. No. 5,340,873 to Mitry discloses a cyanoacrylate adhesive composition having improved toughness by including an effective toughening amount of a polyester polymer derived from a dibasic aliphatic or aromatic carboxylic acid and a glycol.

U.S. Pat. No. 5,994,464 to Ohsawa et al. discloses a cyanoacrylate adhesive composition containing a cyanoacrylate monomer, an elastomer miscible or compatible with the cyanoacrylate monomer, and a core-shell polymer being compatible, but not miscible, with the cyanoacrylate monomer.

There continues to be a need for cyanoacrylate adhesives with improved toughness and peel strengths.

### SUMMARY OF THE INVENTION

As used herein, all compositions values are given in weight percent unless otherwise noted.

The present invention is directed to, in a first aspect, a cyanoacrylate composition which demonstrates enhanced peel strength including: a cyanoacrylate component; and a toughening agent comprising poly(vinyldene chloride-co-acrylonitrile) in combination with fumed silica.

In another aspect, the present invention is directed to a cyanoacrylate composition which demonstrates enhanced toughness including: a cyanoacrylate material; a toughening agent comprising poly(vinyldene chloride-co-acrylonitrile) in combination with fumed silica; and one or more additives selected from the group consisting of plasticizers, accelerators, fillers, opacifiers, thickeners, viscosity modifiers, inhibitors, thixotrophy conferring agents, stabilizers, dyes, thermal degradation reducers, and combinations thereof, where upon cure, the cyanoacrylate composition has an average peel strength of more than about 1 N/mm after curing at room temperature for about 72 hours and a post cure at about 121° C. for about 2 hours.

In still yet another aspect, the present invention is directed to cyanoacrylate adhesive composition including about 1% to about 20% by weight of a toughening agent including poly(vinyldene chloride-co-acrylonitrile) in combination with about 1 to about 10% by weight fumed silica; one or more additives selected from the group consisting of accelerators, fillers, opacifiers, thickeners, viscosity modifiers, inhibitors, thixotrophy conferring agents, stabilizers, and combinations thereof; with the balance being cyanoacrylate.

In yet another aspect, the present invention is directed to a method of bonding two or more substrates including the steps of: providing at least two substrates; dispensing, on at least a portion of a surface of one or both of the at least two substrates, a cyanoacrylate composition including about 1- about 20% by weight of poly(vinylidene chloride-co-acrylonitrile) in combination with from about 1 to about 10% by weight of fumed silica; contacting the surfaces of the at least two substrates having the cyanoacrylate composition there between; and curing the cyanoacrylate adhesive composition.

In still another aspect, the present invention is directed to a bonded assembly including: a first substrate having a first surface; another substrate having a second surface; and a cured cyanoacrylate composition disposed between the first and second surfaces, the composition having included prior to cure: a cyanoacrylate component; and a toughening agent comprising about 1 to about 20% by weight poly(vinylidene chloride-co-acrylonitrile) in combination with from about 1-10% by weight of fumed silica. Once cured, the toughening agent is copolymerized with the cyanoacrylate component forming an interpenetrating molecular network with the cyanoacrylate component. Preferably, the peel strength of the composition is greater than about 1N/mm after room temperature cure for about 72 hours.

### DETAILED DESCRIPTION OF THE INVENTION

The cyanoacrylate compositions of the present invention include toughening agents which provide enhanced peel strengths while providing thermal resistance and toughness in the cured compositions. The toughening agent useful in the present invention comprises poly(vinylidene chloride-co-acrylonitrile). A method of bonding substrates and the resultant bonded assembly are disclosed herein as well.

The cyanoacrylate compositions of the present invention include a cyanoacrylate component which include cyanoacrylate monomers, such as those represented by the structure:

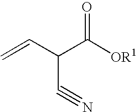

where R¹ is selected from C₁₋₁₆ alkyl, alkoxyalkyl, cycloalkyl, alkenyl, aralkyl, aryl, allyl and haloalkyl groups. Preferably, the cyanoacrylate monomer is selected from methyl cyanoacrylate, ethyl-2-cyanoacrylate, propyl cyanoacrylates, butyl cyanoacrylates (such as n-butyl-2-cyanoacrylate), octyl cyanoacrylates, allyl cyanoacrylate, β-methoxyethyl cyanoacrylate and combinations thereof. A particularly desirable cyanoacrylate monomer is ethyl-2-cyanoacrylate. The cyanoacrylate component should be included in the compositions in an amount within the range of about 70% by weight to about 90% by weight, preferably about 75% by weight to about 85% by weight.

The compositions of the present invention may also contain additives such as stabilizers, accelerators, plasticizers, fillers, opacifiers, thickeners other than silica, viscosity modifiers, inhibitors, thixotrophy conferring agents other than silica, dyes, fluorescence markers, thermal degradation reducers, adhesion promoters, and combinations thereof, and the like. These additives are known to those of skill in the art.

The cyanoacrylate monomers are preferably stabilized using acid stabilizers of the Lewis or protonic types although combinations of nonvolatile sulfonic acids with gaseous stabilizers such as NO, SO₂, SO₃, BF₃, and HF can provide a synergistic effect. A preferred stabilizer system for the present invention includes methane sulfonic acid (“MSA”) and SO₂. Preferably, the amount of MSA is about 5 to about 25 ppm and a preferred amount of SO₂ is about 2 to about 30 ppm based on the amount of the cyanoacrylate monomer. More preferably, BF₃, another acidic gaseous stabilizer, may also be added in amounts of about 5 ppm to about 50 ppm based on the amount of the cyanoacrylate monomer. Advantageously, such small amounts of stabilizers used with the compositions of the present invention provide optimal performance without stability concerns.

Inhibitors or free radical scavengers that may be useful in the cyanoacrylate compositions are of the phenolic type such as hydroquinone, t-butyl catechol, p-methoxy-phenol, and the like. A preferred inhibitor of the present invention is hydroquinone. The inhibitor is present in an amount of about 0.001% by weight to about 2.0% by weight, preferably about 0.02% to about 0.5% by weight. Other inhibitors suitable for use herein include butylated hydroxytoluene and butylated hydroxyanisole.

Accelerators that may be useful in the cyanoacrylate compositions include for example calixarenes, oxacalixarenes, and combinations thereof. Of the calixarenes and oxacalixarenes, many are known, and are reported in the patent literature. See e.g. U.S. Pat. Nos. 4,556,700, 4,622,414, 4,636,539, 4,695,615, 4,718,966, and 4,855,461, the disclosures of each of which are hereby expressly incorporated herein by reference.

Another potentially useful accelerator component is a crown ether. A host of crown ethers are known. For instance, examples which may be used herein either individually or in combination, or in combination with the calixarenes and oxacalixarenes described above include 15-crown-5, 18-crown-6, dibenzo-18-crown-6, benzo-15-crown-5, dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphthyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Other suitable accelerators include those described in U.S. Pat. No. 5,312,864 (Wenz), which are hydroxyl group derivatives of an α-, β- or γ-cyclodextrin which is at least partly soluble in the cyanoacrylate; in U.S. Pat. No. 4,906,317 (Liu), which are silacrown compounds to accelerate fixturing and cure on de-activating substrates such as wood, examples of which are within the following structure:

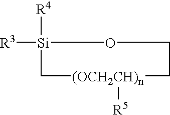

wherein R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups such as methoxy, and aryloxy groups such as phenoxy. The R³ and R⁴ groups may contain halogen or other substituents, an example being trifluoropropyl. However, groups not suitable as R⁴ and R⁵ groups are basic groups such as amino, substituted amino and alkylamino.

Specific examples of silacrown compounds useful in the inventive compositions include:

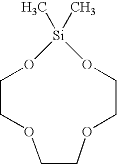

dimethylsila-11-crown-4;

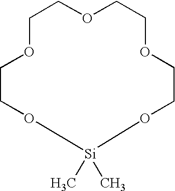

dimethylsila-14-crown-5;

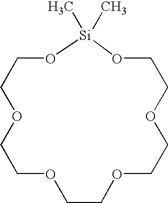

and dimethylsila-17-crown-6.

The accelerator component should be included in the compositions in an amount within the range of from about 0.1% to about 10% by weight, with the range of about 0.5% to about 5% by weight being desirable, and about 0.1% to about 1% by weight of the total composition being particularly desirable.

Phthalic anhydride and other plasticizers may also be added to the cyanoacrylate component to further aid in durability and impact, heat, and moisture resistance. The plasticizer is preferably present in an amount of about 0.005% by weight to about 5.0% by weight, more preferably about 0.01% by weight to about 2.0% by weight of the total composition.

The inventive compositions may also be thickened by the addition of thickeners, such as polymethyl methacrylate, in order to increase viscosity. Thickeners should be included in the inventive composition in an amount less than about 15%, such as within the range of about 0.5% to about 10%, by weight of the total composition.

The combination of the cyanoacrylate monomer and the additives will be referred to herein as the cyanoacrylate component.

The cyanoacrylate compositions of the present invention are typically cured using an anionic mechanism. The layer of moisture inherently adsorbed on the surfaces of virtually all materials is sufficient to initiate polymerization of the cyanoacrylate component. Further, most substrates also contain alkaline or nucleophilic ingredients or as impurities which can initiate the anionic polymerization. The hydroxyl groups of the water molecules effectively act to initiate polymerization as carbanions are generated at a rapid rate. The polymerization reaction will continue until all available monomer is consumed or until growth is inhibited by an acidic species.

The toughening agent of the present invention comprise poly(vinylidene-co-acrylomitrile) in combination with fumed silica.

The invention cyanoacrylate adhesive compositions are readily prepared by adding predetermined amounts of the toughening agent and the fumed silica to the cyanoacrylate component and stirring or agitating for a sufficient time at an appropriate temperature to achieve a homogenous solution or suspension. Typically, temperatures much above room temperature are not necessary as the polymer toughening agents, except for silica, tend to readily dissolve in the cyanoacrylate component. However, in formulations containing high levels of fillers, thickeners, and the like, moderate heating may be desirable to speed up dissolution.

The cyanoacrylate adhesive compositions of the present invention are useful in bonding two or more substrates. A sufficient portion of the adhesive composition may be placed on a surface of one of the two or more substrates. The other substrate is then positioned adjacent to the cyanoacrylate composition and the two substrates are placed contact to form an assembly, upon curing of the cyanoacrylate. Unexpectedly, typical fixturing speeds of the cyanoacrylate compositions of the present invention for bonding EPDM rubber were less than about 70 seconds, and typically between 12 and 40 seconds.

The improved toughness of the cured compositions of this invention is manifested through various physical properties, such as 180° peel strength. High peel strengths are indicative of tough bonds. Peel strength was determined in accordance with American Standard Test Method (ASTM) No. D-903-49, the substance of which is hereby expressly incorporated herein by reference.

The present invention may be better understood through consideration of the following examples which are intended to be illustrative rather than limiting.

### EXAMPLES

The following examples describe the preparation and use of the cyanoacrylate compositions of the present invention. These examples are presented for the purpose of further illustrating and explaining the invention, and are not to be taken as limiting the scope of the invention.

A series of cyanocrylate adhesive compositions was prepared and tested. The samples were prepared by agitation/mixing or tumbling a closed vessel to obtain a homogenous dispersion or solution of the additions in the cyanoacrylate. Peel strengths were evaluated by bonding flexible steel strips together and curing for 24 hours at a temperature of 25° C. The force required to cause the bond to fail was measured, the results are presented in units of force per unit length of bond. The peel test procedure was performed according to ASTM D-903-49. Also measured was the fixturing time, the time required to develop a bond on EPDM rubber samples, shorter fixturing times are generally preferred.

The adhesive compositions and the test results are presented in Table I.

| | | | | Peel | | |
|---|---|---|---|---|---|---|
| | | | | Strength | EPDM | |
| | | Composition | | [N/mm] | [s] | Remark |
| 01 | | EtCA | | 0.4 | | control |
| 02 | | LOCTITE 424 | | 0.4 | | control |
| 03 | | LOCTITE 380 | | 2.9 | 120 | control |
| 04 | | LOCTITE 480 | | 4.1 | 75 | control |
| 05 | EtCA | +7.5% PVeneCAN | | 2.3 | | |
| 06 | EtCA | +9% PVeneCAN | | 3.3 | 20 | |
| 07 | EtCA | +10% PVeneCAN | | 2.9 | 30 | |
| 08 | EtCA | +15% PVeneCAN | | 2.5 | | |
| 09 | EtCA | +20% PVeneCAN | | 2.1 | | |
| 10 | EtCA | +30% PVeneCAN | | 0.5 | | |
| 11 | EtCA | +10% PVeneCAN | +0.4% Calix | 3.1 | 22 | |
| 12 | EtCA | +9% PVeneCAN | +4% PMMA | 2.8 | | |
| 13 | EtCA | +9% PVeneCAN | +3% Silica | 3.2 | | |
| 14 | EtCA | +9% PVeneCAN | +4% Silica | 3.4 | | |
| 15 | EtCA | +11% PVeneCAN | +3% Silica | 3.1 | | |
| 16 | EtCA | +11% PVeneCAN | +6% Silica | 3.6 | | |
| 17 | EtCA | +9% PVeneCAN | +4% BzBuPht | 2.9 | | |
| 18 | EtCA | +9% PVeneCAN | +4% GTA | 3.6 | | |
| 19 | EtCA | +9% PVeneCAN | +4% nBuCA | 2.6 | | |
| 20 | Loctite424 | +10% PVeneCAN | | 4.2 | | |
| 21 | Loctite431 | +5% PVeneCAN | | 1.3 | 17 | After ½ yr: 30 s; 1.68 N/mm |
| 22 | Loctite431 | +5% PVeneCAN | +4% Silica | 1.6 | 18 | After ½ yr: 24 s; 3.61 N/mm |
| 23 | Loctite431 | +9% PVeneCAN | +4% Silica | 3.7 | 28 | |
| 24 | EtCA | +10% PVCVA(I) | | 1.3 | | |
| 25 | EtCA | +10% PVCVA(II) | | 1.4 | | |
| 26 | EtCA | +10% PVCVA(III) | | 1.1 | | |
| 27 | EtCA | +15% PVCVA(III) | | 1.1 | | |
| 28 | EtCA | +20% PVCVA(III) | | 0.7 | | |

| 29 | Loctite431 | +5% PVeneCAN | +5% PVCVA(III) | 2.2 | | |
|---|---|---|---|---|---|---|
| 30 | {Loctite431 + EtCA [1:1]} + 4.5% PVeneCAN | | | 2.1 | 26 | After ½ yr: 32 s; 1.67 N/mm |
| 31 | {Loctite431 + EtCA [1:1]} + 4.5% PVeneCAN + 4% Silica | | | 4.5 | 28 | After ½ yr: 30 s; 3.99 N/mm |
| 32 | EtCA + 7% PVeneCAN + 5% PMMA +2.75% Silica | | | 5.4 | 35 | |
| 33 | EtCA + 7% PVeneCAN+5% PMMA + 2.75% Silica + 4% GTA | | | 5.6 | 40 | |
| 34 | EtCA + 7% PVeneCAN + 5% PMMA +2.75% Silica + 4% TEAC | | | 5.0 | 40 | |
| 35 | iPrCA | +10% PVeneCAN | | 2.1 | 50 | |
| 36 | iPrCA | +10% PVeneCAN | +4% Silica | 2.8 | 60 | After ½ yr: 65 s; 3.48 N/mm |
| 37 | Loctite431 | +10% PVCVA (II) | | 1.99 | 12 | |
| 38 | Loctite431 | +10% PVCVA (II) | +3% Silica | 0.96 | 18 | |

| | | | | |
|---|---|---|---|---|
| 39 | {Loctite431/EtCA [19:3]} | + 6% PVCVA(II) + 3% Silica | 2.36 | 17 |

BzBuPht = Benzyl butyl phtalate
Calix. = Calixarene derivative (fixture speed accelerator)
EPDM = Fixture time on EPDM foam rubber cord
EtCA = Ethylcylanoacrylate monomer
GTA = Glycerol triacetate
iPrCA = Iso-Propyl cyanoacrylate monomer
nBuCA = nButyl cyanoacrylate monomer
Peel Strengt = Peel Strength on degreased mild steel
PMMA = Polymetylmethacrylate (thickening agent)
PVCVA(I) = Poly(vinylchloride-co-vinyl acetate), 86% vinylchloride
PVCVA(II) = Poly(vinylchloride-co-vinyl acetate), 90% vinylchloride
PVCVA(III) = Poly(vinylchloride-co-vinyl acetate), 81% vinylchloride
PVeneCAN = Poly(vinylidene chloride-co-acrylonitrile), 20% acrylonitrile
TEAC = Triethyl-O-acetyl citrate

The substrates used in determining peel strength are sand blasted steel bonded to sand blasted, flexible steel shims. Unexpectedly, typical fixturing speeds of the cyanoacrylate compositions of the present invention for these substrates were less than about 70 seconds, and in most cases, from 12-40 seconds.

Non toughened cyaoacrylate adhesive compositions have low peel strengths, typically from about 0.2-0.4 N/mm. Example 01 and 02 illustrate the low peel strengths of non toughened cyanoacrylate adhesives.

Examples 05-10 demonstrate the effect of adding various amount of poly(vinylidene-chloride-co-acrylonitrile) to an ethyl cyanoacrylate monomer. It can be seen that poly(vinylidene-chloride-co-acrylonitrile) additions of up to 30% provide enhanced peel strengths relative to Example 01. Maximum benefits are seen at about 9-10% poly(vinylidene-chloride-co-acrylonitrile), and toughness drops when more than about 20% poly(vinylidene-chloride-co-acrylonitrile) is added.

Examples 06, 13 and 14 suggest that adding fumed silica to poly(vinylidene chloride-co-acrylonitrile) toughened cyanoacrylate further and improves peel strength. Examples 07, 15 and 16 further support the observation that fumed silica, in combination with poly(vinylidene-chloride-co-acrylonitrile), provides improved peel strengths. The benefit of fumed silica additions to poly(vinylidene-chloride-co-acrylonitrile) in cyanoacrylate adhesive compositions can also be seen by comparing Examples 21 and 22, Examples 35 and 36, and Examples 30 and 31.

These Examples confirm the benefit provided by adding fumed silica to poly(vinylidene chloride-co-acrylonitrile) toughened cyanoacrylate compositions.

The cyanoacrylate adhesive compositions of the present invention exhibit improved peel strengths in comparison with cyanoacrylate compositions toughened with prior art tougheners such as BLACK MAX® (Loctite 380 cyanoacrylate adhesive, an adhesive known for its high peel strength).

What is claimed is:

1. A cyanoacrylate composition comprising:
a. a cyanoacrylate component; and
b. a toughening agent comprising poly(vinylidene-chloride-co-acrylonitrile) in combination with fumed silica.

2. The composition of claim 1 wherein said cyanoacrylate component comprises a monomeric structure represented by: 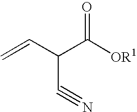
wherein R¹ is C₁₋₁₅ alkyl, alkoxyalkyl, cycloalkyl, alkenyl, aryl, aralkyl, allyl, alkyhalide, or haloalkyl and mixtures thereof.

3. The composition of claim 2 wherein said cyanoacrylate component comprises a member selected from the group consisting of methyl cyanoacrylate, ethyl-2-cyanoacrylate, propyl cyanoacrylates, butyl cyanoacrylates, octyl cyanoacrylates, allyl cyanoacrylates, β-methoxyethyl cyanoacrylate, and mixtures thereof.

4. The composition of claim 3 wherein said cyanoacrylate component comprises ethyl-2-cyanoacrylate.

5. The composition of claim 1 wherein said poly(vinylidene-chloride-co-acrylonitrile)is present in an amount of about 1% to about 20% by weight.

6. The composition of claim 1 wherein said fumed silica is present in an amount (by weight) of from about 0.5 to about 10%.

7. The composition of claim 1 further comprising at least one additive selected from the group consisting of stabilizers, accelerators, plasticizers, fillers other than fumed silica, opacifiers, thickeners, viscosity modifiers, inhibitors, thixotrophy conferring agents other than fumed silica, dyes, thermal degradation enhancers, and combinations thereof.

8. The composition of claim 1 wherein upon cure, the cyanoacrylate composition has an average peel strength in excess of about 1.0 N/mm after 72 hours at room temperature cure.

9. A cyanoacrylate composition comprising:
a. a cyanoacrylate component;
b. a toughening agent comprising poly(vinylidene-chloride-co-acrylonitrile) in combination with fumed silica; and
c. one or more additives selected from the group consisting of stabilizers, accelerators, plasticizers, fillers other than fumed silica, opacifiers, thickeners, viscosity modifiers, inhibitors, thixotrophy conferring agents other than fumed silica, dyes, thermal degradation inhibitors, and combinations thereof,
wherein upon cure, the cyanoacrylate composition has an average tensile shear strength in excess of about 1.0 N/mm.

10. The composition of claim 9 wherein the poly(vinylidene-chloride-co-acrylonitrile) is present in an amount of 1-20%.

11. The compositions of claim 9 wherein the colloidal silica is present in an amount, by wt., of 1-10%.

12. A method of bonding two or more substrates comprising the steps of:
a. providing at least two substrates;
b. dispensing, on a surface of one or both of the at least two substrates, a cyanoacrylate adhesive composition of claim 1;
c. contacting the surfaces of the at least two substrates having the cyanoacrylate adhesive composition thereon; and
d. exposing the cyanoacrylate adhesive composition to cure conditions.

13. The method of claim 12 wherein after the step of contacting the surfaces of the at least two substrates having the cyanoacrylate adhesive composition thereon, the fixturing time of the cyanoacrylate composition is less than about 70 seconds.

14. The method of claim 12 wherein the at least two substrates comprise EPDM rubber and the bond has a fixturing time of less than 70 seconds, and after curing the bond has a peel strength in excess of 1 N/mm.

15. A bonded assembly comprising:
a. a first substrate having a first surface;
b. another substrate having a second surface; and
c. a cured cyanoacrylate adhesive composition disposed between said first and second surfaces, said composition, prior to cure, comprising:
i. a cyanoacrylate component; and
ii. a toughening agent comprising poly(vinylidene-chloride-co-acrylonitrile) in combination with fumed silica; the toughening agent forming an interpenetrating molecular network with the cyanoacrylate component upon curing.

16. The bonded assembly of claim 15 wherein the bonded assembly demonstrates a peel strength greater than about 1.0 N/MM after room temperature cure of about 72 hours.

17. The bonded assembly of claim 15 wherein the cured cyanoacrylate adhesive has a multi-phase structure comprising a matrix phase which comprises a solid solution of the cyanoacrylate material, said matrix containing a second phase which comprises the toughening agent, and a dispersion of silica particles.
